(19) United States
(12) Patent Application Publication
(10) Pub. No.: US 2015/0259174 A1
(43) Pub. Date: Sep. 17, 2015

(54) CONDITION MONITORING OF VERTICAL TRANSPORT EQUIPMENT

(71) Applicant: ABB OY, Helsinki (FI)

(72) Inventor: Matti MUSTONEN, Helsinki (FI)

(73) Assignee: ABB OY, Helsinki (FI)

(21) Appl. No.: 14/645,143

(22) Filed: Mar. 11, 2015

(30) Foreign Application Priority Data
Mar. 12, 2014 (EP) 14159107.3

(51) Int. Cl. B66B 5/00

(52) U.S. Cl. CPC B66B 5/0018

(57) ABSTRACT

A method and arrangement are disclosed for detecting a working condition of a mechanical brake of vertical transport equipment, the vertical transport equipment including a frequency converter, an electrical motor and a mechanical brake. Movement of the vertical transport equipment can be controlled using a frequency converter configured to feed electrical power to the motor, the mechanical brake being configured to mechanically hold a car or load of the vertical transport equipment. Data relating to deceleration of the car or load is used as reference data. The mechanical brake is controlled into a closed position for decelerating movement of the car or load. Test data, relating to deceleration of the car or load is measured from information or from a control system of the frequency converter, and compared with reference data.

### RELATED APPLICATION(S)

This application claims priority to European Application No. 14159107.3 filed in Europe on Mar. 12, 2014. The content of which is hereby incorporated by reference in its entirety.

### FIELD

The disclosure relates to monitoring a condition of vertical transport equipment, and for example, to determining a working condition of mechanical brakes of an elevator.

### BACKGROUND INFORMATION

Vertical transport equipment, such as lifts or elevators, are intended for moving goods or persons between floors of a building, decks of a vessel, for example. Similarly, cranes or similar lifting devices can be used for transporting goods from one place to another by lifting the goods and moving them horizontally.

Modern elevators and similar lifting devices can be equipped with electric motors, which can be driven using frequency converters. Frequency converters can be devices with which an electric motor can be controlled. A frequency converter can output a voltage having a variable frequency to the controlled motor. The frequency of the voltage can be set as desired so that the motor can be rotated as desired.

In frequency converters controlling the motor of the elevator, a controller structure can be that the outermost control loop can control the position of the rotor of the motor. The position of an elevator car can be controlled to a desired position. The output of the position controller can be fed to a speed controller that can control the speed of rotation of the rotor and thus the speed of the elevator car.

The output of the speed controller can be fed to a torque controller controlling the torque that the motor can produce. The required torque can be produced by modulating the output switches of the frequency converter such that the current fed to the motor produces the necessary torque.

With the above-described exemplary structure, the travel of the elevator car can be controlled precisely so that the elevator decelerates to stop in correct positions. Due to safety reasons, whenever the car of the elevator or load of a crane is in standstill, a mechanical brake can be applied to mechanically engage the rotor of the motor so that the elevator car or the load can stay securely in place.

The mechanical brakes can also be used for stopping the load in normal deceleration operation at low speeds. Further, the brakes can be put to use whenever the load needs to be emergency-stopped.

As the mechanical brakes wear down during use, the condition of the brakes should be checked regularly. One way to inspect the brakes or the wear of brake pads can be to visually inspect the wear. The visual inspection uses maintenance personnel to be physically present in the machine room of the elevator and the elevator to be put temporarily out of service. Since the visual inspection may not be reliable, the brake pads might be replaced all too often or all too seldom.

Instead of inspecting the brake pads, another solution is to replace the brake pads regularly, based on operation time or on calendar time. Although the wear of the brake pads can somehow be predicted, the regular replacement does not take into account environmental conditions, such as heat or dirt, and the brake pads may be changed all too often or all too seldom.

Separate sensors may also be used to detect the movement of the brake pads in a mechanical brake system. Such additional dedicated sensors can make the system complex and therefore susceptible to defective operation.

### SUMMARY

A method is disclosed of detecting a working condition of a mechanical brake of vertical transport equipment, the vertical transport equipment including a frequency converter, an electrical motor and a mechanical brake, wherein movement of the vertical transport equipment being controlled using the frequency converter is configured to feed electrical power to a motor and the mechanical brake is configured to mechanically hold a car or load of the vertical transport equipment when the car or load is stationary, the method comprising: storing data relating to deceleration of the car or load as reference data; controlling the mechanical brake into a closed position for decelerating movement of the car or load: determining test data relating to the deceleration of the car or load from measured information or from a control system of the frequency converter; comparing the reference data with the test data; and producing an alarm signal based on the comparison between the reference data and the test data.

An arrangement is disclosed for detecting a working condition of a mechanical brake of vertical transport equipment, the vertical transport equipment including a frequency converter, an electrical motor and a mechanical brake, movement of the vertical transport equipment being controlled using the frequency converter configured to feed electrical power to a motor and using the mechanical brake configured to mechanically hold a car or load of the vertical transport equipment when the car or load is stationary, the arrangement comprising: means for storing data relating to deceleration of a car or load for use as reference data; means for controlling the mechanical brake into a closed position for decelerating movement of the car or load; means for determining test data relating to the deceleration of the car or the load from measured information or from a control system of a frequency converter; means for comparing the reference data with the test data; and means for producing an alarm signal based on the comparison between the reference data and the test data.

### BRIEF DESCRIPTION OF THE DRAWINGS

The disclosure is explained below with reference to the exemplary embodiments shown in the drawings. In the drawings:

FIG. 1 is shows an exemplary simplified controller structure of a frequency converter in accordance with an exemplary embodiment;

FIG. 2 shows exemplary speed and deceleration curves; and

FIG. 3 shows exemplary speed and torque curves.

### DETAILED DESCRIPTION

In accordance with an exemplary embodiment, a method and an arrangement for implementing the method are disclosed, which can use a frequency converter for implementing brake diagnostics without separate sensors. The diagnostics can be implemented by putting the mechanical brake to use when the elevator car or the like is moving and in the process of decelerating to a standstill. When the mechanical brakes are used, information can be gathered from the frequency converter. The gathered information may be, for example, speed data during the deceleration. In accordance with an exemplary embodiment, this data can be compared with previous data gathered in similar tests or obtained from new brake pads. If such a test sequence indicates that the deceleration can be lowered, the appropriate personnel may be informed about the appearing fault.

In accordance with an exemplary embodiment, the method and arrangement as disclosed can simplify the diagnostics of wear of mechanical brakes. Further, the condition monitoring of the brakes can be carried out during the normal operation of the vertical transport device without interruptions in the service.

Frequency converters can enable mechanical brakes, which can be used for braking mechanical movement associated with the load of the frequency converter to be controlled. In connection with the use in elevators or other vertical transport equipment, a frequency converter can control the movement of the load, for example, the elevator car in a hoistway or the load of a crane. The frequency converter can also control the mechanical brakes for securely holding the load in place after the load has entered a standstill state. In normal operation, the frequency converter can first control the elevator car into a desired position on the basis of position information, and after the desired position has been reached and after the elevator car has stopped moving, the frequency converter can send a command to the mechanical brakes so that the brakes tightly clamp the shaft of the rotor. In connection with cranes or hoists, the stopping positions may not be predetermined, so that when the user of the crane decides to stop the load, and when the vertical movement of the load is stopped, the frequency converter can send a command to the mechanical brakes to mechanically clamp the mechanics of the system.

In the following, the vertical transport equipment can be generally referred to as an elevator.

In accordance with an exemplary embodiment for detecting the condition of the mechanical brakes of an elevator, reference data relating to deceleration of the elevator car when mechanical brakes are put to use can be determined and stored. For example, the reference data can be determined and stored while commissioning the elevator or after replacing the brake pads. The reference data can be determined and stored by executing a specific program on the frequency converter. The same program can be executed during use of the elevator for gathering test data for determining the working condition of the mechanical brakes.

In this program, the elevator car can be moved to a known position at a normal speed. Once the elevator car approaches the known position and decelerates to stop, the frequency converter can send a command to the mechanical brakes to engage the mechanics of the system. For example, the mechanical brakes clamp the rotor of the driving motor.

Simultaneously with sending the command to the mechanical brakes, the frequency converter can start determining and storing data relating to the deceleration.

The data relating to the deceleration can be, for example, speed data, deceleration data or position data. The gathered data can be obtained, for example, directly from the frequency converter as the frequency converter can determine the rotational speed of the motor and thus the linear speed of the elevator car. Further, the position of the elevator car can be known by the frequency converter. The position of the elevator car can be known, for example, by integrating the speed of the elevator car. The integration can be reset each time the elevator car is stationary in a known position, and thereby the position of the car can be kept accurate. The acceleration data can be obtained from the speed data, for example, in a known manner.

When the elevator car is moving under the control of a frequency converter, the frequency converter can control the movement by using controllers built in the frequency converter. When a mechanical brake is applied during controlled operation, the control considers this as disturbance and can compensate for the effect of the disturbance by changing the torque producing current to the motor. During this controlled operation, depending on the tuning of the controllers and the braking torque of the mechanical brake, the deceleration, speed, and position data may be only slightly changed from the operation without any mechanical brake. The effect of the torque caused by the mechanical brake can be noticed at a time instant when the mechanical brakes start applying torque on the rotor.

The determined data relating to deceleration of the elevator car may also be the output of the torque controller of the frequency converter controlling the motor. The speed controller can react to the counter torque produced by the mechanical brakes. Further, the determined data may be either measured or estimated current of the motor. As the control system tries to control the speed and position of the elevator car as desired, the controllers can change the current to the motor for overcoming the disturbance. Similarly, as the mechanical brakes change the speed of the elevator car, the output of the speed controller reacts to the disturbance, and thus the data at the output of the speed controller can be gathered for reference data and for test data during use.

Another possibility to determine the data is to change the operation of the control system for the duration of the tests. The control system can be, for example, modified such that a torque or current controller of the control system can be disabled. As the mechanical brake is applied in response to the command sent by the frequency converter, the torque or current controller can be disabled. As a result, the frequency converter does not produce any current to the motor and the mechanical brake can stop the motion of the elevator car. Speed and position controllers still operate so that data relating to deceleration can be gathered from the output of the controllers. Alternatively, the speed of the motor can be estimated by the control system or read from the sensors if such are available. It should be noted that as the torque or current controller is disabled, the speed of the elevator car should be rather low when the test is carried out. Even at low speeds, the data relating to deceleration can be enough to show the wear of the brake pads or malfunction of some other part of the braking system.

The torque or current controller can be disabled for example by disabling the output from the controllers or by setting a zero value to the output of the controllers. A safety function can be implemented in the procedure by detecting the speed of the motor. If the motor speed increases during the test procedure, the current or torque controller can be put to use immediately.

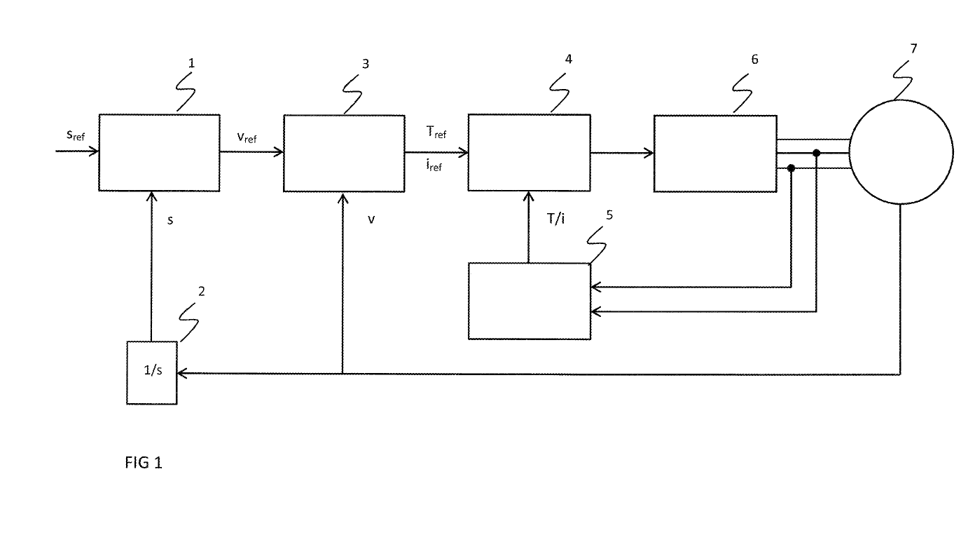

FIG. 1 shows an example of a control system of a frequency converter in which the above procedures can be implemented. The outermost control loop is the position control controlling the position of the motor and thus the elevator car in a hoistway. Feedback for the position controller 1 can be integrated 2 from the speed information and a reference value for a position s_{ref} is based on call signals. Thus, in a building, each possible floor at which the elevator car can stop is a possible position. Further, the elevator system can include limit switches, which monitor the passage of the car and inform the control system accordingly.

The output of the position controller is fed to the input of the speed controller 3 as a speed reference v_{ref} and the other input of the speed controller receives speed information v either from a separate sensor or from a motor model incorporated in the frequency converter. As the actual position is not correct, the output from the position controller deviates from zero, and thereby a speed reference is given to the speed controller.

The output of the speed controller is further connected to the input of the torque or current controller 4 as a torque or current reference T_{ref}/i_{ref}. The actual current can be either measured or estimated and fed to the other input of the controller. If the actual current deviates from the reference given by the speed controller, the output voltage of the frequency converter can be changed so that the error between the reference and actual current can be minimized. The operation is the same when a torque controller is used in place of a current controller. As the torque cannot be easily measured, the actual torque T can be obtained from the motor model 5, which can calculates the state of the motor by using measured, for example, currents and voltages.

The output of the torque or current controller can be fed to a modulator 6, which further can control the output switches of the frequency converter for feeding a desired current to the motor 7.

The above short description of an exemplary control system is given to illustrate the operation of the system and to show the data that can be determined and gathered from the control system.

The decision as to whether the working condition of the mechanical brakes has dropped below an allowable limit or to an alarm limit can be made by comparing the reference data with the data determined during a test sequence. An alarm signal may be given once a change is noticed from the reference data. The alarm signal can be generated by the frequency converter such that it can be readable on a panel of the frequency converter. Further, the frequency converter may send the alarm signal to an upper level control system and, for example, to a maintenance center or another such facility monitoring the operation of the elevators.

In accordance with an exemplary embodiment, the decision about the working condition can be based on consecutive tests or on a single test. In consecutive tests, test data can be gathered and stored. The stored test data can be analyzed automatically such that if the consecutive tests show that, for example, the deceleration is lowering each time a test is performed, it can be concluded that an alarm signal should be given. In accordance with an exemplary embodiment, a limit may be set and the test results can be compared with the limit value. If the limit is exceeded, an alarm signal can be produced. The limit can be, for example, set on the basis of the reference data. If, for example, the gathered data is deceleration, the reference value may be an average of deceleration from the time instant at which the mechanical braking is applied to the time instant at which the car is stopped. During test measurements, the car is decelerated to zero speed from the same travel speed. If the deceleration has decreased, for example over 10 percent, from the reference measurement, an alarm signal can be given.

The wear of the brakes can also be determined by measuring the time required to stop the elevator car. When the car is decelerated to stop by using the mechanical brakes, the increased time when compared with reference data can indicate the wear of the brakes.

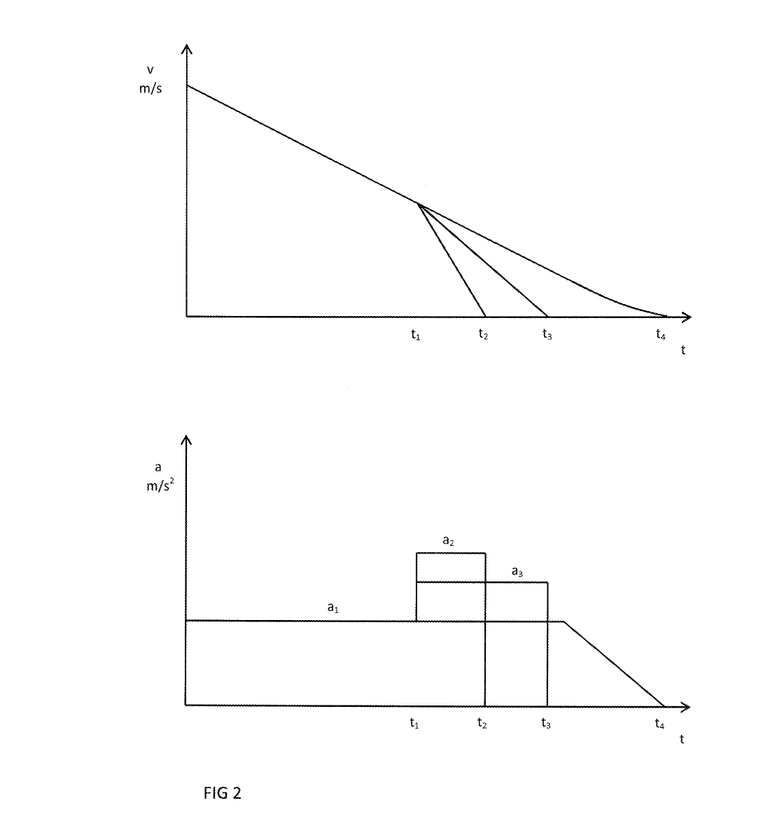

FIG. 2 shows the speed of the elevator car as a function of time and corresponding deceleration profile when the elevator car is braked to a standstill. As seen in FIG. 2, the speed of the elevator car is decreased and at time instant t₁, the frequency converter can send a command to apply the mechanical brakes and at the same time, the torque or current control can be disabled. The mechanical brakes apply a constant force to the mechanics of the system, and the deceleration can be increased. At time instant t₂ the elevator car is stopped. FIG. 2 shows another measurement of speed with a decreased performance of the mechanical brakes. The brakes can again be applied at time instant t₁, and now a stand-still situation is reached at time instant t₃. The lower plot shows the deceleration relating to the speed. The example of FIG. 2 shows the speed changing linearly, i.e. the acceleration has a constant value a₁ prior to application of the mechanical brakes, a₂ with the deceleration ending at t₂, and a₃ with the deceleration ending at t₃. FIG. 2 also shows normal deceleration of the elevator car. The deceleration profile is linear and ends at t₄.

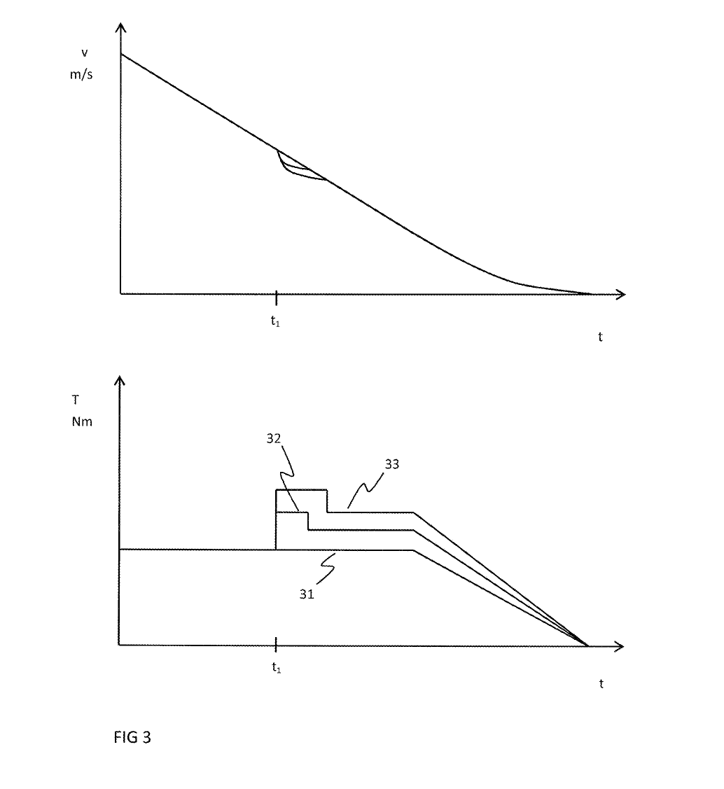

FIG. 3 shows the current waveforms when the torque or current controller is kept operational during the test. When the mechanical brake is applied at time instant t₁, the speed of the elevator car can be lowered and the output of the speed controller increases the torque or current reference. FIG. 3 illustrates how the speed can be temporarily decreased due to the force of the mechanical brake. The lower curve shows the input to the torque controller. As the speed changes, the torque demand can increase to keep the speed as necessary. After the dip in speed, the torque can remain at a higher level to compensate for the force applied by the mechanical brake. The level of torque can depend on the wear of the brakes. In FIG. 3, a torque curve 31 represents the case without mechanical brake, a curve 33 with a high force applied by the brakes, and a curve 32 with worn mechanical brakes. The speed curves show the corresponding speed curves, in which the greatest change in speed can be due to a force corresponding to the curve 33 and the smaller dip relates to the torque curve 32.

The reference and test data gathered when the controllers are operational can be, for example, the highest value of torque as presented in FIG. 3. The torque data used for testing the condition of the mechanical brakes can be, for example, a torque reference or a current reference. As is known, the current fed to the motor corresponds to the torque generated by the motor, that is, the torque of the motor can be controlled by controlling the current.

A test sequence can be automatically triggered, for example, once a week. The frequency converter may comprise a logic, which can trigger the test after a certain time period has elapsed from a previous test. Further, the test may be performed when the volume of traffic on the elevator is low, for example, during nighttime or when the elevator has been idle for a certain time period.

The test on an elevator may also be carried out during the normal use of the elevator. The elevator system can detect when the elevator car is empty. When an empty car is called to a certain position, and when the time from a previous test has exceeded a predetermined time interval, a test sequence can be carried out. The elevator car should be empty when performing the test as the weight of the passengers might affect the determined values.

In connection with cranes or hoists, each stop from a normal speed without excessive load can be used as a test sequence.

As disclosed above, the reference data and the test data can be gathered in a similar manner. The reference data can be, for example, stored while commissioning the elevator or the like or after replacing the brake pads or devices affecting the braking force.

In the arrangement of the disclosure, the elevator, hoist, crane or similar vertical transport equipment can include a frequency converter which can include means for storing data relating to deceleration of the car or the load for use as reference data. In accordance with an exemplary embodiment, for example, frequency converters can hold different parameters and measurements in their internal memory. This memory can also be used for storing the reference data and the test data. Further, a frequency controller can include a controlled output, which can be used in the disclosure for producing a signal controlling the mechanical brake. Further, the frequency converter can include a program code or the like, which can determine the test data in a manner similar to that in connection with the reference data. The frequency converter may also process the data and carry out the comparison between the gathered data. The frequency converter may also produce an alarm signal based on the comparison.

FIGS. 2 and 3 representing speed, deceleration and torque curves are provided as examples for the purpose of better understanding the disclosure. The curves do not represent any actual measurement or simulation data. Similarly, the block diagram of FIG. 1 represents an example of a control system without any specific details of the operation of the control system. In accordance with an exemplary embodiment, it can be clear to a skilled person that the controller structure that may be employed in connection with the present disclosure can be produced in many ways in a manner known per se.

It will be apparent to a person skilled in the art that as technology advances, the inventive concept can be implemented in many different ways. The disclosure and its embodiments are not limited to the examples described above but may vary within the scope of the claims.

Thus, it will be appreciated by those skilled in the art that the present invention can be embodied in other specific forms without departing from the spirit or essential characteristics thereof. The presently disclosed exemplary embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A method of detecting a working condition of a mechanical brake of vertical transport equipment, the vertical transport equipment including a frequency converter, an electrical motor and a mechanical brake, wherein movement of the vertical transport equipment being controlled using the frequency converter is configured to feed electrical power to a motor and the mechanical brake is configured to mechanically hold a car or load of the vertical transport equipment when the car or load is stationary, the method comprising:
storing data relating to deceleration of the car or load as reference data;
controlling the mechanical brake into a closed position for decelerating movement of the car or load:
determining test data relating to the deceleration of the car or load from measured information or from a control system of the frequency converter;
comparing the reference data with the test data; and
producing an alarm signal based on the comparison between the reference data and the test data.

2. The method according to claim 1, comprising:
disabling torque or current control of the frequency converter.

3. The method according to claim 2, wherein the data relating to deceleration is speed or deceleration of the car or load.

4. The method according to claim 1, wherein the data relating to deceleration is torque of the control system of the frequency converter.

5. The method according to claim 4, wherein the data relating to deceleration is a maximum value of the torque of the control system of the frequency converter.

6. The method according to claim 1, wherein the data relating to deceleration is current of the control system of the frequency converter.

7. The method according to claim 6, wherein the data relating to deceleration is a maximum value of the current of the control system of the frequency converter.

8. The method according to claim 1, comprising:
producing the alarm signal when the comparison of the reference data with the test data exceeds an alarm limit.

9. The method according to claim 1, comprising:
producing the alarm signal when a change is detected between the comparison of the reference data and the test data, and the detected change exceeds an allowable limit.

10. The method according to claim 1, wherein the reference data is deceleration, which is an average of deceleration from a time instant at which mechanical braking is applied to a time instant at which the car is stopped, the method comprising:
producing the alarm signal if the deceleration has decreased over a set limit from the reference data.

11. An arrangement for detecting a working condition of a mechanical brake of vertical transport equipment, the vertical transport equipment including a frequency converter, an electrical motor and a mechanical brake, movement of the vertical transport equipment being controlled using the frequency converter configured to feed electrical power to a motor and using the mechanical brake configured to mechanically hold a car or load of the vertical transport equipment when the car or load is stationary, the arrangement comprising:
means for storing data relating to deceleration of a car or load for use as reference data;
means for controlling the mechanical brake into a closed position for decelerating movement of the car or load;
means for determining test data relating to the deceleration of the car or the load from measured information or from a control system of a frequency converter;
means for comparing the reference data with the test data; and
means for producing an alarm signal based on the comparison between the reference data and the test data.

12. The arrangement according to claim 11, comprising:
means for disabling torque or current control of the frequency converter.

13. The arrangement according to claim 12, wherein the data relating to deceleration is speed or deceleration of the car or load.

14. The arrangement according to claim 11, wherein the data relating to deceleration is torque of the control system of the frequency converter.

15. The arrangement according to claim 14, wherein the data relating to deceleration is a maximum value of the torque of the control system of the frequency converter.

16. The arrangement according to claim 11, wherein the data relating to deceleration is current of the control system of the frequency converter.

17. The arrangement according to claim 16, wherein the data relating to deceleration is a maximum value of the current of the control system of the frequency converter.

18. The arrangement according to claim 11, wherein the alarm signal is produced when the comparison between the reference data and the test data exceeds an alarm limit.

19. The arrangement according to claim 11, wherein the alarm signal is produced when a change is detected between the comparison of the reference data and the test data, and the detected change exceeds an allowable limit.

20. The arrangement according to claim 11, in combination with vertical transport equipment which includes the frequency converter, the electric motor and the mechanical brake, wherein the reference data is deceleration, which is an average of deceleration from a time instant at which mechanical braking is applied to a time instant at which a car to be held by the mechanical brake is stopped, wherein the alarm signal will be produced if the deceleration has decreased over a set limit from the reference data.
